(19) United States
(12) Patent Application Publication
(10) Pub. No.: US 2026/0317967 A1
(43) Pub. Date: Oct. 15, 2026

(54) FLEECE STRUCTURE AND/OR FABRIC STRUCTURE AND FLEECE- AND/OR FABRIC-STRUCTURE PRODUCTION PROCESS

(71) Applicant: PHI-STONE AG, Mielkendorf (DE)

(72) Inventors: Ala COJOCARU, Kiel (DE); Iris HAYES, Schoenkirchen (DE); Daniel HUGENBUSCH, Rodenbek (DE); Andreas ROTH, Schwedeneck (DE); Hartmut SCHMIDT-NIEPENBERG, Ahrensboek (DE)

(73) Assignee: PHI-STONE AG, Mielkendorf (DE)

(21) Appl. No.: 19/484,348

(22) PCT Filed: May 15, 2024
(86) PCT No.: PCT/DE2024/100448

§ 371 Date: Nov. 13, 2025

(30) Foreign Application Priority Data
May 16, 2023 (DE) 10 2023 112 953.8

(51) Int. Cl. D04H 1/413; D04H 1/4218; D04H 1/4291; D04H 1/4382; D04H 1/56; D04H 3/16; D06M 11/44; D06M 101/20

(52) U.S. Cl. CPC D04H 1/413; D04H 1/4218; D04H 1/4291; D04H 1/43832; D04H 1/56; D04H 3/16; D06M 11/44; D06M 2101/20; D10B 2321/021; D10B 2321/022; D10B 2509/00

(57) ABSTRACT

A nonwoven and/or fabric structure wetted and/or impregnated with macroscopic, three-dimensional, positively charged particles, wherein the macroscopic, three-dimensional, positively charged particles are tetrapodal zinc oxide and interlocking structures are present in the fabric structure and/or nonwoven fabric structure with the macroscopic, three-dimensional, positively charged particles arranged on the surface of the fabric structure and/or nonwoven fabric structure. Furthermore, a nonwoven and/or fabric structure manufacturing method for a nonwoven and/or fabric structure with macroscopic, three-dimensional, positively charged particles.

The invention relates to a fleece and/or fabric structure.

Furthermore, the invention relates to a fleece and/or fabric structure production process for a fleece and/or fabric structure.

The prior art includes corresponding nonwoven and/or fabric structures, which are formed in particular by novel nanoparticles with antimicrobial properties, i.e., in particular antiviral and antibacterial properties. Currently, antimicrobial particles are loosely incorporated into nonwoven fabrics, which means that their release, especially through washing out and mechanical stress, cannot be prevented. Known solutions include nano-silver, which does not adhere permanently to the fabric/nonwoven due to its small particle size. There is a risk of inhalation and skin irritation from the nanoparticles and their release. Insufficient adhesion to the fabric/nonwoven leads to a limited duration of action due to the release of the particles. Nano silver is a form of silver that has been reduced to a very small size, i.e., silver particles less than 100 nanometers in size. In medicine, nano silver is used in the manufacture of wound dressings, implants, catheters, and other medical devices to prevent or treat infections due to its antimicrobial properties. In the textile industry, nanosilver is used in the manufacture of textiles and clothing to reduce the formation of odors and the growth of bacteria and fungi. However, the inventors recognized that this type of nanosilver has significant disadvantages, making substitution necessary.

CH 717 692 A1 discloses a filter for filtering particles with a negatively charged surface, in particular anionic particles with a polar, negatively charged surface, from a fluid, in particular viruses and/or bacteria from the air, comprising a carrier material, preferably a permeable porous carrier material, and a cationically acting agent which is covalently bound to the carrier material. The cationic agent has a molecular weight of less than 1000, in particular less than 200, when covalently bound to the carrier material.

In addition, AT 516 414 A1 discloses a nonwoven fabric containing cellulose fibers that incorporate at least partially zinc oxide particles and is additionally impregnated with a liquid, as well as a method for its production and its use, in particular for the production of preservative-free wet wipes.

The problem with the prior art is essentially that the currently known antimicrobial properties of nanosilver entail potential toxicity when released. The effects of nanosilver on the environment and human health are therefore to be viewed critically, as silver cannot be broken down in the body and possible side effects in this regard include effects on the central nervous system and the sense of taste, as well as gait disorders, dizziness, or seizures due to the absorption of nanosilver.

The question of better combinations of nonwoven and/or fabric structures with antimicrobial function is considered necessary on this side. The present invention is based on the task of improving a nonwoven and/or fabric structure from the prior art in such a way that an antibacterial and antiviral (antimicrobial) design is possible and there are no negative effects on the environment or the body, whereby the cost factor should also be taken into account so that the manufacturing costs for such nonwoven and/or woven structures are kept as low as possible. A further task is to demonstrate a corresponding nonwoven and/or woven structure manufacturing process.

This task is solved with a nonwoven and/or woven structure according to the claim 1. Furthermore, the task can be solved by a nonwoven and/or woven structure manufacturing method for a nonwoven and/or woven structure according to the adjacent claim. Further advantageous embodiments can be found in the subclaims.

The nonwoven and/or woven structure wetted and/or impregnated with macroscopic, three-dimensional, positively charged particles wherein
the macroscopic, three-dimensional, positively charged particles are tetrapodal zinc oxide and
interlocking structures are present in the fabric structure and/or nonwoven structure with the macroscopic, three-dimensional, positively charged particles arranged on the surface of the fabric structure and/or nonwoven structure.

Macroscopic, three-dimensional, positively charged particles are particles that are visible on a macroscopic scale and have a spatial extension. They are generally larger than nanoparticles, which typically have a size of less than 100 nanometers.

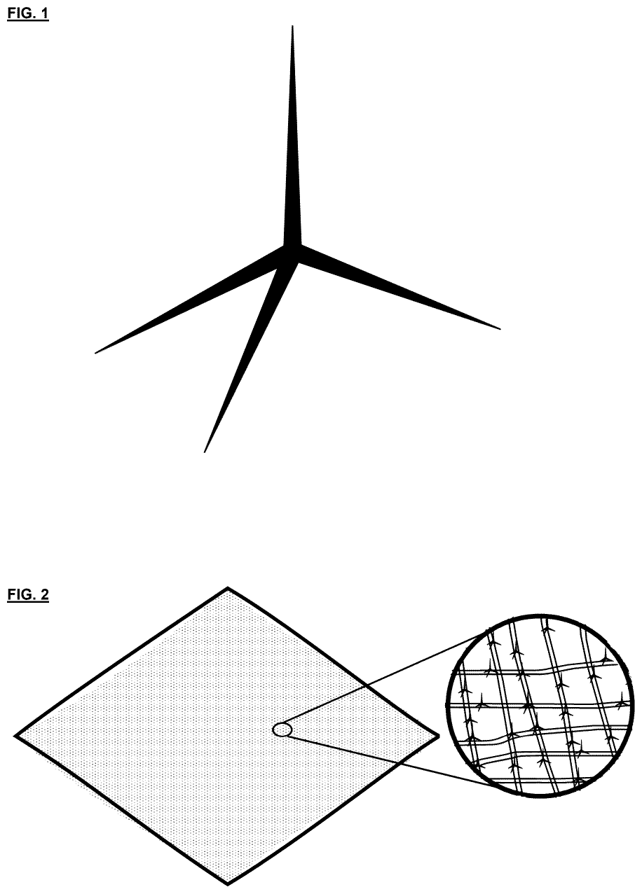

Tetrapodal zinc oxide is a special form of zinc oxide that has a unique shape (see FIG. 1). It consists of tetrapodal, i.e., four-armed, crystalline structures that, unlike other forms of zinc oxide, have a higher specific surface area. The higher specific surface area of tetrapodal zinc oxide makes it a material suitable for use in medicine and, as described below, it can be used in wound care in various wound dressings to reduce inflammation and bacterial growth and promote wound healing, in particular to exploit its antimicrobial effect.

Furthermore, the macroscopic, three-dimensional, positively charged particles can, should, or must have a non-spherical morphology, i.e., they can crystallize as wires, rods, tubes, tetrapods, or multipods, for example. The particles should therefore have non-spherical nanostructures. However, medical compatibility is important here, so that only medically safe materials should or must be used. In terms of hazardousness, the aspect of very good adhesion is also decisive, so that even materials that are not completely harmless can still be used due to their good adhesion. The following materials could certainly be used: aluminum oxide, silver oxide, titanium oxide, yttrium oxide, cerium oxide, copper oxide, magnesium oxide, iron oxide, calcium oxide, silicon oxide, or in the form of pure metals.

The nonwoven and/or fabric structure can be selected in particular from one of the following lists or a combination of the following lists:
Nonwoven and/or filter nonwoven layer for mouth-nose protection,
Nonwoven and/or filter nonwoven layer for breathing masks,
Nonwoven and/or filter nonwoven layer for filter systems,
Filter nonwoven for respiratory masks,
Wound dressing, nonwoven fabric for a wound dressing, plaster
Textiles, socks, sportswear, underwear,
Nonwoven structure for diapers,
Nonwoven structure for incontinence and/or period underwear,
Nonwoven fabric for feminine hygiene products.

A mouth-nose protection, also known as a mask, is a protective device used to prevent microorganisms from entering the body through the respiratory tract, whereby the mouth-nose protection covers the mouth and nose and can be made of various materials, including fabric, paper, medical or surgical tissue, or special filter materials, in particular nonwoven structures. Face masks are commonly used in medicine and healthcare to reduce the spread of pathogens and infections through droplet infection. There are different types of mouth-nose protection masks, including simple mouth-nose coverings made of fabric or paper that cover the nose and mouth area, as well as medical or surgical masks made of special filter material that offer a higher level of protection. The appropriate design of the mouth-nose protection with corresponding macroscopic, three-dimensional, positively charged particles, in particular tetrapodal zinc oxide, causes the macro-particles to bind and inactivate micro-organisms located in a liquid film generated by respiratory air.

The special morphology of the macroscopic, three-dimensional, positively charged particles, i.e., the tetrapodal zinc oxide, ensures that the macroparticles are permanently bound in the fleece, effectively preventing the particles from being washed out, thereby increasing the service life of the mask and enhancing sustainability, cost efficiency, and user safety. In particular, known nanoparticles such as nanosilver are not used.

Permanent use or at least significantly longer use is possible due to interlocking structures in fabric structures or fleece structures, as microorganisms can be effectively bound and inactivated by the macroscopic, three-dimensional, positively charged particles, in particular tetrapodal zinc oxide, arranged on the surface of the fabric structures or fleece structures.

This protects humans from microorganisms and protects humans and the environment from the release of potentially environmentally hazardous toxic nanoparticles, as known in the prior art. Wound dressings are materials that are applied directly to the skin or a wound to support healing and protect the wound. They can be made from a variety of materials, including cotton, foam, hydrocolloid, alginates, and many others. Wound dressings can be used in different ways, depending on the type of wound and the specific healing requirements. For example, some wound dressings are designed to retain moisture in the wound, while others can help to wick away excess moisture. The wound dressings may have antimicrobial properties to prevent or treat infections due to the configuration shown here.

Antimicrobial textiles are textiles that have been treated with antimicrobial agents to inhibit or prevent the growth of bacteria, fungi, and other microorganisms. The macroscopic, three-dimensional, positively charged particles, in particular tetrapodal zinc oxide, are applied either to the yarn, the fabric, or the finished product. Antimicrobial textiles are used in various applications, such as medicine, sports, workwear, and underwear. In sports, antimicrobial textiles are used to manufacture sportswear and sports equipment, to reduce the growth of odor-causing bacteria. In workwear and underwear, antimicrobial textiles are used to manufacture clothing and equipment to reduce the growth of bacteria and fungi, thereby improving hygiene and comfort.

However, it is important to note that there are no concerns regarding the potential toxicity of the macroscopic, three-dimensional, positively charged particles used here, in particular tetrapodal zinc oxide.

Feminine hygiene products are products specifically designed for women's personal hygiene. These products include various items that can be used for menstruation, intimate hygiene, and general personal care. Some of the most common feminine hygiene products are:
Sanitary pads: Absorbent pads worn in underwear to collect blood during menstruation;
Tampons: Small cylindrical pads that are inserted into the vagina to absorb blood during menstruation;
Panty liners: Thin, absorbent pads that can be worn in underwear to absorb discharge or light bleeding;
Intimate care wipes: Moist wipes specially designed for intimate hygiene.

Furthermore, the nonwoven and/or fabric structure may in particular be a medical nonwoven and/or fabric structure, wherein the medical nonwoven and/or fabric structure as well as the nonwoven and/or fabric structure can be designed as a microbial binder, wherein the microbial binding is effected by the macroscopic, three-dimensional, positively charged particles in the nonwoven and/or fabric structure.

The nonwoven and/or woven structure can be made in particular from fibers, cotton, hemp, cellulose, and/or synthetic fibers.

Furthermore, the nonwoven and/or woven structure may consist of glass fibers or contain glass fibers.

The nonwoven and/or woven structure manufacturing method for a nonwoven and/or woven structure with macroscopic, three-dimensional, positively charged particles is characterized in that the macroscopic, three-dimensional, positively charged particles are applied and/or introduced by means of a dispersion or a suspension by:
spraying and/or rolling and/or rolling with pressing of the macroscopic, three-dimensional, positively charged particles onto the nonwoven and/or woven structure
   and/or
spraying and/or soaking and/or dipping and/or pressing the nonwoven and/or woven structure with macroscopic, three-dimensional, positively charged particles
   and/or
applying and incorporating by forming the macroscopic, three-dimensional, positively charged particles as an additive during the production of the nonwoven fibers.

Furthermore, an alcohol-based dispersion, in particular isopropanol, or correspondingly a water-based suspension with a neutral pH value, can be used for this purpose.

The roll-to-roll process can be used as a preferred application or incorporation method to ensure industrial-scale production.

A dispersion is a mixture of solid particles in a liquid phase. There are various methods for applying a dispersion to a fiber, which can be used depending on the type of fiber and dispersion. Here are a few options:
Dip method: The fiber is dipped into the dispersion and then pulled out, and the dispersion medium is then allowed to evaporate. The particles settle on the fiber and form a coating. This method is well suited for porous fibers such as cotton or wool.
Spraying method: The dispersion is sprayed onto the fiber, either as an aerosol or with a spray bottle. This method is particularly suitable for synthetic fibers such as polyester or nylon.
Coating process: The dispersion is applied to the fiber by pulling the fiber through a coating machine or system. This method is often used in the manufacture of technical textiles such as filters or membranes.

The invention is described below with reference to the accompanying figures in the figure description, which are intended to explain the invention and are not necessarily to be considered limiting. Tetrapodal zinc oxide is discussed in particular as a particularly preferred embodiment:

Shown:

FIG. 1 a single t-ZnO particle;

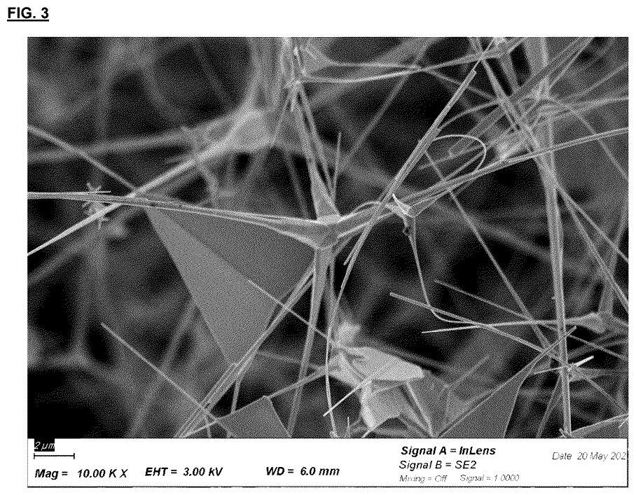

FIG. 2 a schematic representation of a nonwoven fabric according to the invention with tetrapodal zinc oxide;

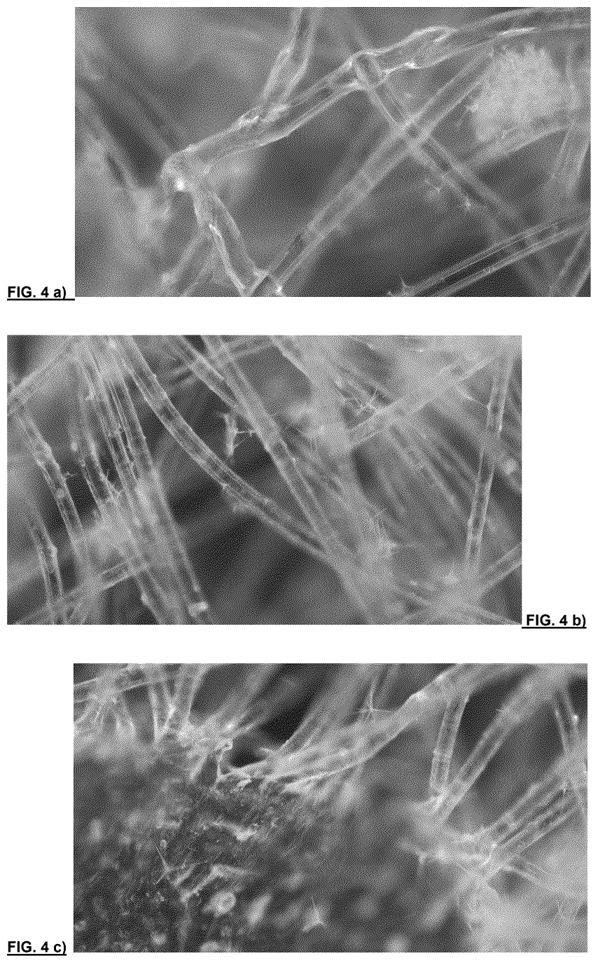

FIG. 3A scanning electron microscope (SEM) image of the tetrapodal ZnO particle. The SEM image was taken using a Zeiss Ultra Plus (Carl Zeiss Microscopy GmbH, Jena, Germany) SEM.

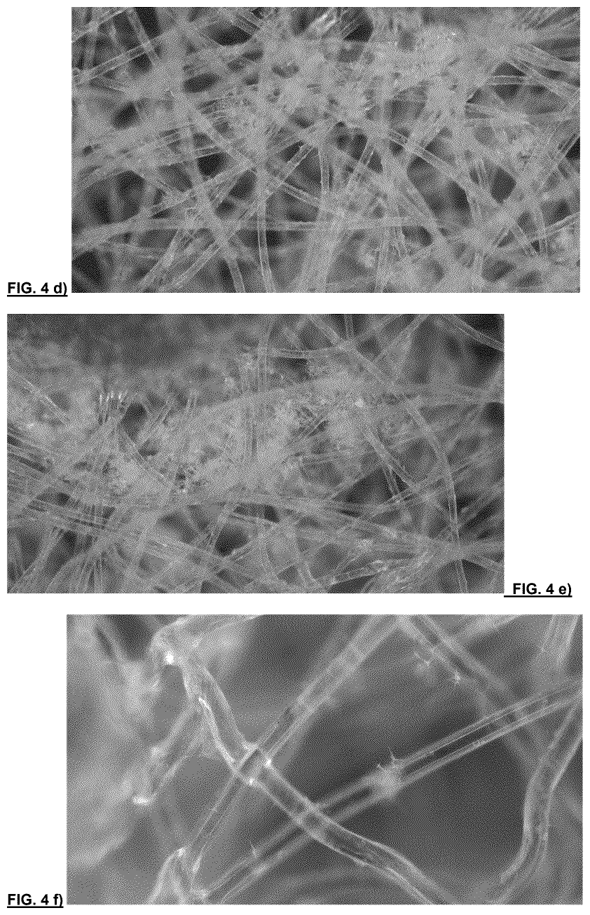

FIG. 4 Optical images of tetrapodal ZnO particles embedded in a propylene fabric. The image was taken using a Zeiss optical microscope.

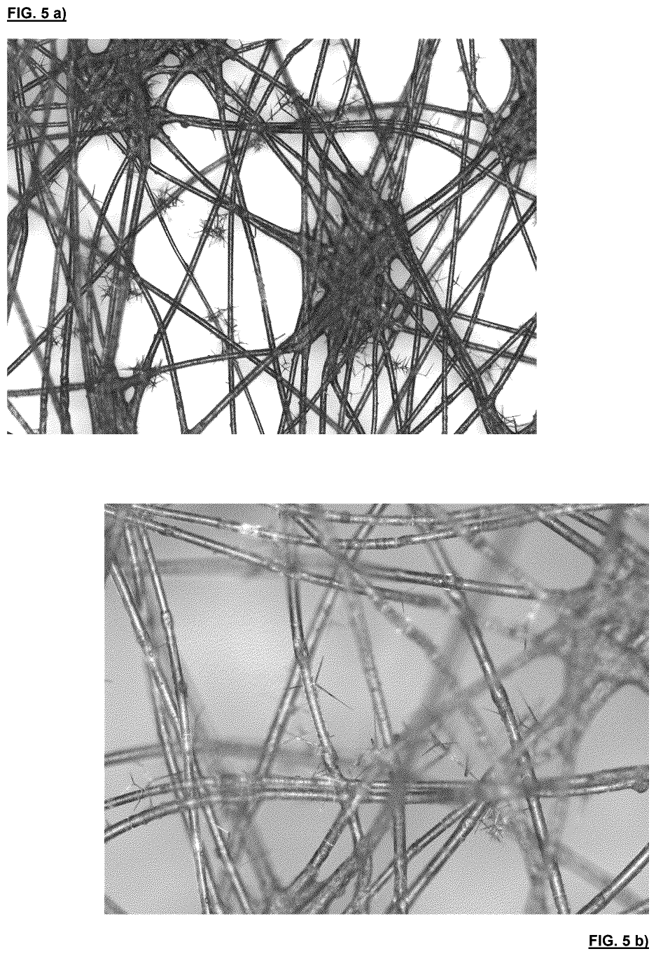

FIG. 5 Optical images of the tetrapodal ZnO particles embedded in the propylene fabric after impregnation. The image was taken using an optical laser confocal microscope from Keyence.

FIG. 1 shows an image of a single t-ZnO particle, revealing the structure of this particular spike-like particle. Due to its special shape, the particle “gets caught” particularly well in fabrics or nonwovens, reducing the risk of it coming loose.

FIG. 2 shows a schematic representation of a nonwoven fabric or fabric structure with tetrapodal zinc oxide according to the invention. To illustrate the structure, a magnified image is shown in which it is easy to see how the fibers and the tetrapodal zinc oxide particles are combined with each other. It is not absolutely necessary for the tetrapodal zinc oxide particles to completely enclose the fibers of the structure; rather, it is sufficient for the particles to be distributed approximately homogeneously, but not necessarily evenly, over the structure. The particles adhere to the structure by themselves and can maintain this adhesion almost permanently, so that, in contrast to known structures, there is no detachment of the applied tetrapodal zinc oxide particles. Moisture introduced during use of the fabric/nonwoven material causes the microbes to spread to the ZnO tetrapods, so that no comprehensive coverage by t-ZnO is necessary.

FIG. 3 shows a scanning electron microscope (SEM) image of the tetrapodal zinc oxide particle (t-ZnO). The SEM image was taken with a Zeiss Ultra Plus (Carl Zeiss Microscopy GmbH, Jena, Germany) SEM. A large, tetrapodal ZnO structure can be seen in the center of the image, which is particularly well suited for incorporation into fabrics and/or nonwovens due to its morphology.

FIG. 4 shows optical images of tetrapodal zinc oxide particles embedded in a propylene fabric, with different images a) to f) shown here. The images were taken with a Zeiss optical microscope. In these examples, nonwovens with particularly large mesh sizes were chosen to make the adhering tetrapods particularly visible. For applications, it makes sense to use finer fabrics and/or nonwovens, as the t-ZnO particles “hook” into these better and adhesion is further improved.

FIG. 5 also shows optical images of the tetrapodal zinc oxide particles, here embedded in propylene fabric after impregnation of the fabric. The image was taken with an optical laser confocal microscope from Keyence. In this case, too, particularly coarse carrier materials were selected in order to make the applied t-ZnO particles more visible.

Below, an example is used to explain a possible application of tetrapodal zinc oxide to a nonwoven structure, whereby this is intended to explain the invention and not necessarily limit its scope.

Mouth-nose masks known in the prior art usually consist of at least three nonwoven layers. These nonwoven layers are usually made of plastics such as polypropylene or ethylene-propylene. Such nonwovens are produced by a spinning process as spunbond or by a meltblown process as meltblown nonwovens. The simplest design is a combination of two outer spunbond nonwovens with a meltblown nonwoven in the middle as a mouth-nose protection. In this case, it is sufficient to coat the meltblown nonwoven fabric in the middle, which is usually made of polypropylene, with tetrapodal zinc oxide so that the tetrapodal zinc oxide has an antimicrobial effect in the layer.

The following table shows the samples used as examples:

| | | | | | | Max |
|---|---|---|---|---|---|---|
| | raw material | Type of supply | Specification | Quantity | Location | temperature |
| Number 1 | Polypropylen- | Roll with width | Material thickness | 90-110 mm | mask body | 165° C. |
| | Spunbond | 250 mm | 50 g/m² | per mask | Inner layer | |
| Number 2 | Polypropylen- | Roll with width | Material thickness | 90-110 mm | mask body | 165° C. |
| | Meltblown | 250 mm | 13 g/m² | per mask | Filter layer | |
| Number 3 | Polypropylen- | Roll with width | Material thickness | 90-110 mm | mask body | 165° C. |
| | Meltblown | 250 mm | 25 g/m² | per mask | Filter layer | |
| Number 4 | Polypropylen- | Roll with width | Material thickness | 90-110 mm | mask body | 165° C. |
| | Spunbond | 250 mm | 13 g/m² | per mask | Inner layer | |
| Number 5 | Polypropylen- | Roll with width | Material thickness | 90-110 mm | mask body | 165° C. |
| | Spunbond | 185 mm | 25 g/m² | per mask | Outer layer | |
| Number 6 | Polypropylen- | Roll with width | Material thickness | 90-110 mm | mask body | 165° C. |
| | Meltblown | 175 mm | 25 g/m² | per mask | Filter Layer | |
| Number 7 | ES Ethylene- | Roll with width | Material thickness | 90-110 mm | mask body | 130° C. |
| | Propylene Side | 250 mm | 35 g/m² | per mask | Outer layer | |
| | BySide (PE/PP) | | | | | |

The samples were cut into 100×100 mm pieces and weighed before impregnation. The following three methods were used: spraying, rolling, and dipping.

The following three options were prepared for impregnation:
a. 0.01 g t-ZnO+10 ml H2O
b. 0.01 g t-ZnO+10 ml isopropanol
c. 0.1 g t-ZnO+50 ml isopropanol

The samples were weighed before impregnation (m1) and after drying (m2).

Spray variant: The entire solution containing t-ZnO (tetrapodal zinc oxide) was sprayed onto a 10 cm² sample. To accurately determine the amount of ZnO on the sample, the samples were weighed before and after spraying. The samples were dried before weighing to ensure that the weight consisted only of the ZnO quantity and was not influenced by excess moisture. By accurately measuring the t-ZnO quantity on the sample before and after spraying, it was possible to determine the quantity of t-ZnO that remained on the sample.

| | Solution | | |
|---|---|---|---|
| | Spray a. | | |
| Sample | m1, g | m2, g | m t-ZnO |
| 2 | 0.1336 | 0.1422 | 0.0086 |
| 3 | 0.2346 | 0.2422 | 0.0076 |
| 6 | 0.2733 | 0.2823 | 0.009 |
| | Solution | | |
| | Spray b. | | |
| Sample | m1, g | m2, g | m t-ZnO, g |
| 2 | 0.132 | 0.1391 | 0.0071 |

Variant rollers: A smooth, non-porous roller surface was chosen to prevent t-ZnO particles from sticking to the surface. The solution was applied both horizontally and vertically.

| | Rollers c. | | |
|---|---|---|---|
| Sample | m1, g | m2, g | m t-ZnO |
| 2 | 0.1376 | 0.1463 | 0.0087 |
| 3 | 0.2352 | 0.2445 | 0.0093 |
| 5 | 0.3378 | 0.3438 | 0.006 |

Dipping variant: The dipping method was not very successful when using water, as the material has a hydrophobic surface. For this reason, an alcohol-based solution was used instead, which allowed for better adhesion to the surface of the material.

| | Solution | | |
|---|---|---|---|
| | Dipping c. | | |
| Sample | m1, g | m2, g | m ZnO |
| 1 | 0.4568 | 0.4785 | 0.0217 |
| 2 | 0.1345 | 0.1387 | 0.0042 |
| 3 | 0.2791 | 0.2846 | 0.0055 |

1. A nonwoven and/or woven structure wetted and/or impregnated with macroscopic, three-dimensional, positively charged particles;
wherein
the macroscopic, three-dimensional, positively charged particles are tetrapodal zinc oxide
and
interlocking structures are present in the woven structure and/or nonwoven structure with
the macroscopic, three-dimensional, positively charged particles arranged on the surface of the woven structure and/or nonwoven structure.

2. The nonwoven and/or woven structure according to claim 1,
wherein
the nonwoven and/or woven structure is selected from one of the following lists or a combination of the following lists:
nonwoven and/or filter nonwoven layer for mouth-nose protection,
nonwoven and/or filter nonwoven layer for breathing masks,
nonwoven and/or filter nonwoven layer for filter systems,
filter nonwoven for respiratory masks,
wound dressing, nonwoven structure for a wound dressing, bandage
textiles, socks, sportswear, underwear,
nonwoven structure for diapers,
nonwoven structure for incontinence and/or period underwear,
nonwoven structure for feminine hygiene products.

3. The nonwoven and/or woven structure according to claim 1
wherein
the nonwoven and/or woven structure is a medical nonwoven and/or woven structure, wherein the medical nonwoven and/or woven structure is a microbial binder, wherein the microbial binding is effected by the macroscopic, three-dimensional, positively charged particles.

4. The nonwoven and/or woven structure according to claim 1,
wherein
the nonwoven and/or woven structure is made of fibers, cotton, hemp, cellulose, and/or synthetic fibers.

5. The nonwoven and/or woven structure according to claim 1,
wherein
the nonwoven and/or woven structure consists of glass fibers or comprises glass fibers.

6. The nonwoven and/or woven structure manufacturing method for a nonwoven and/or woven structure with macroscopic, three-dimensional, positively charged particles according to claim 1,
wherein
the macroscopic, three-dimensional, positively charged particles are applied and/or introduced by means of a dispersion or a suspension by:
spraying and/or rolling and/or rolling with pressing of the macroscopic, three-dimensional, positively charged particles onto the nonwoven and/or woven structure
and/or
spraying and/or soaking and/or dipping and/or pressing the nonwoven and/or woven structure with macroscopic, three-dimensional, positively charged particles
and/or
applying and incorporating by forming the macroscopic, three-dimensional, positively charged particles as an additive during the production of the nonwoven fibers.

7. The nonwoven and/or woven structure manufacturing method according to claim 6,
wherein
the dispersion is alcohol-based and the suspension is water-based with a pH value in the neutral or slightly acidic range with a pH value >4.
